(19) United States
(12) Patent Application Publication
(10) Pub. No.: US 2004/0023818 A1
(43) Pub. Date: Feb. 5, 2004

(54) Method and product for enhancing the clean-up of hydrocarbon-producing well

(76) Inventors: Philip D. Nguyen, Duncan, OK (US); Johnny A. Barton, Marlow, OK (US)

Correspondence Address: Robert A. Kent, Halliburton Energy Services, 2600 South 2nd Street, Duncan, OK, 73536, US

(21) Appl. No.: 10/212,378

(22) Filed: Aug. 5, 2002

(51) Int. Cl. C09K 3/00

(52) U.S. Cl. 507/209

(57) ABSTRACT

A method for enhancing the clean-up of a hydrocarbon-producing well, in which particles are pumped into the well to promote the recovery of the hydrocarbons. The particles are coated with a water-repellent composition to prevent, or at least minimize, the coating or adsorption of any gel polymer from the carrier fluid for the particles.

### BACKGROUND

After most oil or gas wells are drilled, they do not produce hydrocarbons at a rate to provide satisfactory economic return. Therefore, the oil industry uses a process known as hydraulic fracture stimulation to generate fractures deep into the hydrocarbon-bearing rock formations, which provides highly conductive flow channels to the well. To keep the fractures open after relieving the high pressure used to create them, operators often place a particulate material, or proppant, in the fractures. The particulate material can be in the form of a sand or gravel, or a man-made material, such as ceramic, bauxite, glass spheres, plastic particles, resin-coated proppants, and the like (the particulate material in whatever form will hereinafter be referred to as “particles”).

Also, in the production of hydrocarbon fluids from such fractures, it is sometimes necessary to gravel pack the production zones by placing sieved sand such as gravel in the annulus between sand-control screens and casing (i.e. cased hole) or formation wall (i.e. open hole) to prevent movement or migration of formation sand or fines from the formation during the production of hydrocarbons. Similar to fracturing operations, manmade particles can be used as gravel in gravel packing.

In both of these situations, the particles are usually introduced downhole in a carrier fluid that often includes a water-based gelling polymer to increase its viscosity. However, the polymer is absorbed on the surface of the particles to form a coating which is difficult to remove and which compromises the conductivity of the particles when they are used as a proppant and the permeability of the particles when they are used as a gravel pack.

Therefore what is needed is a method of the above type which permits use of the polymer gel yet eliminates its disadvantages.

### DETAILED DESCRIPTION

According to an embodiment, the particles are dry coated with a water-repellent organo-silicon material. The treated particles are then pumped downhole to the fractures to function as a proppant or to the wellbore-screen annulus to function as a gravel pack.

Representative organo-silicon compounds that can be used in this embodiment include polyalkylsiloxanes such as polymethylsiloxanes, polyethylsiloxanes, and the like. Additional organo-silicon compounds that can be used in this embodiment include polyalkylarylsiloxanes such as polymethylphenylsiloxane, chlorosilanes such as ethylchlorosilane, chlorotrimethylsilane and other silyl donors. Also, various alkoxysilanes, aroxysilanes, alkoxysiloxanes, and aroxysiloxanes can be used such as tetraethoxysilane, dimethoxydiphenylsilane, dichlorodimethylsilane, dichlorodiphenylsilane, poly(dimethylsiloxane, poly[oxy(dimethylsilylene)] and other such materials that will be well known to those skilled in the art. In addition, other organo-silicon oil-soluble compounds can be used including ethyl silicates, methyl sodium silanolate, and other silicon resins such as mixtures of silane esters and silyl amines, as well as tetraethyl orthosilicate, tetramethyl orthosilicate, tetra-n-propyl silicate, tetrabutyl glycol silicate, N-(t-butyidiphenylsilyl)cyclohexylamine, N-(t-butyldiphenylsilyl)benzylamine and other such materials that will be well known to those skilled in the art. Furthermore, organofunctional silanes can be used in this embodiment including gamma-aminopropyltriethoxysilanes, N-beta-(aminoethyl)gamma-aminopropyl-trimethoxysilanes, aminoethyl-N-beta-(aminoethyl)-gamma-aminopropyl-trimethoxysilanes, gamma-ureidopropyl-triethoxysilanes, beta-(3-4epoxy-cyclohexyl)-ethyl-trimethoxysilanes and gamma-glycidoxypropyltrimethoxysilanes.

An example of the technique for applying the coating on the particles involves dissolving an oil-soluble organo-silicon compound in a solvent, admixing or spraying the resultant solution on the particles, and then evaporating the solvent to form a thin film of siloxane or silane encapsulating the particles. The organo-silicon organo-silane compound is readily absorbed onto the particles from the solvent and the solvent is easily evaporated by drying.

If the particles are coated when the particles are flowing, the solvent should be readily miscible in the water-based gel carrier fluid. Organic solvents that can be used as a carrier for the organo-silicon coating material include kerosene, lighter grades of diesel fuel, hexane, xylene, toluene, dipropylene glycol methyl ether, butyl glycidyl ether, triethylene glycol, 2-ethylene hexanol and other such solvents that will be well known to those skilled in the art.

As a non-limiting example, approximately 0.01% to 3% of organo-silicon by weight of particles can be used to coat onto the particles. It is not necessary that the coating of water-repellent material remain permanently on the proppant or gravel particles. It is preferred that the coating material deteriorates, degrades or is otherwise removed from the surface of particles over time so as to restore the particles to the water-wet environment, either caused by erosion as a result of shearing, temperature, or chemical interaction with the hydrocarbon fluid being produced from the reservoir formation.

The coating of the particles in the above manner helps to prevent, or at least minimize, the coating, or adsorption, of the above-mentioned gel polymer from the carrier fluid on the surfaces of the particles. Thus, gel polymer or its residue is readily removed from the system during cleanup or flowback of the well. This greatly enhances the conductivity of the particles when used as a proppant and the permeability of the particles when used as a gravel pack.

Fracturing or gravel packing fluids which can be utilized in accordance with the present invention include gelled water or oil base liquids, foams and emulsions. The foams utilized are generally comprised of water based liquids containing one or more foaming agents foamed with a gas such as nitrogen or air. Emulsions formed with two or more immiscible liquids have also been utilized. A particularly useful emulsion for carrying out formation fracturing procedures is comprised of a water based liquid and a liquified, normally gaseous fluid such as carbon dioxide. Upon pressure release, the liquified gaseous fluid vaporizes and rapidly flows out of the formation.

The most common fracturing fluid utilized heretofore which is generally preferred for use in accordance with this invention is comprised of water, a gelling agent for gelling the water and increasing its viscosity, and optionally, a crosslinking agent for crosslinking the gel and further increasing the viscosity of the fluid. The increased viscosity of the gelled or gelled and crosslinked fracturing fluid reduces fluid loss and allows the fracturing fluid to transport significant quantities of suspended fibrous bundles and proppant into the created fractures.

The water utilized to form the fracturing fluids used in accordance with the methods of this invention can be fresh water, salt water, brine or any other aqueous liquid which does not adversely react other components of the fracturing fluids.

A variety of gelling agents can be utilized including hydratable polymers which contain one or more functional groups such as hydroxyl, cis-hydroxyl, carboxyl, sulfate, sulfonate, amino or amide. Particularly useful such polymers are polysaccharides and derivatives thereof which contain one or more of the monosaccharide units galactose, mannose, glucoside, glucose, xylose, arabinose, fructose, glucuronic acid or pyranosyl sulfate. Natural hydratable polymers containing the foregoing functional groups and units include guar gum and derivatives thereof, locust bean gum, tara, konjac, tamarind, starch, cellulose and derivatives thereof, karaya gum, xanthan gum, tragacanth gum and carrageenan gum. Hydratable synthetic polymers and copolymers which contain the above mentioned functional groups and which have been utilized heretofore include polyacrylate, polymethacrylate, polyacrylamide, maleic anhydride, methylvinyl ether polymers, polyvinyl alcohol and polyvinylpyrrolidone.

Examples of crosslinking agents which can be utilized to further increase the viscosity of the gelled fracturing fluid are multivalent metal salts or other compounds which are capable of releasing multivalent metal ions in an aqueous solution. Examples of the multivalent metal ions are chromium, zirconium, antimony, titanium, iron (ferrous or ferric), zinc or aluminum. The above described gelled or gelled and crosslinked fracturing fluid can also include gel breakers such as those of the enzyme type, the oxidizing type or the acid buffer type which are well known to those skilled in the art. The gel breakers cause the viscous fracturing fluids to revert to thin fluids that can be produced back to the surface after they have been used to create and prop fractures in a subterranean zone.

The proppant or gravel utilized is of a size such that formation particulate solids which migrate with produced fluids are prevented from flowing through the fractures or through the gravel pack in the annulus. Various kinds of particles can be utilized as proppant including sand, bauxite, ceramic materials, glass materials, TEFLON™ materials, curable resin-coated proppant, and the like. Generally the particles used have a particle size in the range of from about 2 to about 400 mesh, U.S. Sieve Series. The preferred particles are sand having a particle size in the range of from about 10 to about 70 mesh, U.S. Sieve Series. Preferred sand particle size distribution ranges are one or more of 10-20 mesh, 20-40 mesh, 40-60 mesh or 50-70 mesh, depending on the particular size and distribution of the formation solids to be screened out by the proppant.

### EXAMPLES

Test 1

300 grams of 20/40 Brady sand was dry coated with 1.5 mL of silicon oil (i.e. 0.5% by weight of proppant) by adding the silicon oil to the sand while stirring the sand with an overhead stirrer. The stirring process was continued for about 20 seconds after which the sand was homogeneously coated with silicon oil. The treated proppant was then added to 300 mL of 40 lb/1000 gal guar gel while the gel fluid was being stirred. The gel slurry was allowed to sit for 30 minutes. Next, the slurry was decanted to remove excess gel before pouring and packing into a flow chamber that has wire screen of 80-mesh installed at the outlet end. Tap water was then allowed to flow through the sand pack for 2 minutes at a flow rate of 1 L/min. After the flow period, the water was drained from the chamber, and sand samples were collected to determine how much guar gum remained attached to the surface of the sand particulate using the guar content analysis method described below.

Test 2

The procedures in test 1 were repeated except that the Brady sand was not coated with silicon oil.

Test 3

300 grams of 20/40 Brady sand was first dry coated with 1.5 mL of silicon oil (i.e. 0.5% by weight of proppant). The treated proppant was then added to 300 mL of 40 lb/1000 gal guar gel while the gel fluid was being stirred. Alkaline buffering agent (0.68 mL) was added to slurry to raise its pH to 10.5. Next, borate cross-linker (0.36 mL) and sodium persulfate breaker (0.12 gram) were added to the slurry. The cross-linked gel slurry was then placed in a 175° F. heat bath and stirring was continued for 20 minutes. After this stirring period, the gel was completely broken. Next, the slurry was decanted to remove excess gel before pouring and packing into a flow chamber that had a wire screen of 80-mesh installed at the outlet end. Tap water was then allowed to flow through the sand pack for 2 minutes at a flow rate of 1 L/min. After the flow period, the water was drained from the chamber, and sand samples were collected to determine how much guar remain attached to the surface of sand particulate using guar content analysis method.

Test 4

The procedures in test 3 were repeated except that Brady sand was not coated with silicon oil.

Guar Content Analysis

3 grams of each sand sample was weighed into a 50-mL flask. The weight of the sample was recorded. Five milliliters of deionized was added to the flask. The flask was placed on a stirring plate and 15 mL of anthrone sulfuric acid was added in increments for 20 minutes. Anthrone is an analytical dye which is mixed with the sulfuric acid and serves as an indicator for the presence of guar gel. The intensity of the color of the anthrone dye corresponds with the level of absorbance or concentration of guar gel dispersed in the sample solution. The sample was allowed to cool to room temperature and the absorbance was read at 626 nm on a UV Spectrophotometer. The absorbance value was then used to determine the concentration of guar gel from a known calibration curve.

Analysis Results

Table 1 shows the results of the guar content analysis. The data indicates that the amount of guar Polymer attached to the sand surface is much more significant for sand that was not coated with silicon oil.

TABLE 1
Effect of Silicon Oil Coating on Polymer Remaining on Proppant Surface

| | |
|---|---|
| Sand sample | Amount of guar remaining |
| weight (grams) | on sand (mg/L) |

Test 1-With Silicon Oil, in Not-Crosslinked Fluid

| | | |
|---|---|---|
| Sample 1 | 3.0644 | 32.0 |
| Sample 2 | 3.0722 | 34.6 |

Test 2-Without Silicon Oil, in Not-Crosslinked Fluid

| | | |
|---|---|---|
| Sample 1 | 3.0122 | 160.4 |
| Sample 2 | 3.1759 | 174.5 |

Test 3-With Silicon Oil, in Crosslinked Fluid

| | | |
|---|---|---|
| Sample 1 | 3.1044 | 32.0 |
| Sample 2 | 3.1981 | 39.2 |

Test 4-Without Silicon Oil, in Crosslinked Fluid

| | | |
|---|---|---|
| Sample 1 | 3.1260 | 57.8 |
| Sample 2 | 3.1355 | 55.2 |

Variations and Equivalents

It is understood that variations may be made in the foregoing without departing from the scope of the invention. For example, the water-repellent material can be coated onto the particles by various other techniques, including spraying, blowing, or wet mixing, after which the coated particles are allowed to dry, a process that can be performed well in advance of shipping the particles to the well site. Also, the particles can be precoated with a curable resin or the like for reasons well known in the art.

Although only a few exemplary embodiments have been described in detail above, those skilled in the art will readily appreciate that many other modifications are possible in the exemplary embodiments without materially departing from the novel teachings and advantages described herein. Accordingly, all such modifications are intended to be included within the scope of the subject matter as defined in the following claims. In the claims, means-plus-function clauses are intended to cover the structures described herein as performing the recited function and not only structural equivalents, but also equivalent structures.

What is claimed is:

1. A method comprising dry coating particles with a water-repelling composition, and pumping the particles downhole into a well to promote the recovery of hydrocarbons from the well.

2. The method of claim 1 wherein the particles are pumped downhole to a screen and function as a gravel pack.

3. The method of claim 1 wherein the particles are pumped downhole to a fracture in a formation adjacent the well and function as a proppant.

4. The method of claim 1 wherein the composition is oil-soluble, and wherein the particles are coated by dissolving the composition in a solvent, admixing or spraying the resultant solution on the particles, and then evaporating the solvent to form a film encapsulating the particles.

5. The method of claim 4 wherein the film comprises an organo-silicon material.

6. The method of claim 5 wherein the organo-silicon material is selected from the group consisting of siloxanes and silanes.

7. The method of claim 1 wherein the composition comprises an organo-silicon material.

8. The method of claim 1 wherein the particles are selected from the group consisting of sand and gravel.

9. The method of claim 1 wherein the particles comprise a man made material.

10. The method of claim 9 wherein the particles comprise a material selected from the group consisting of ceramic, bauxite, glass spheres, plastic particles, and curable resin-coated proppants.

11. The method of claim 1 wherein the composition comprises a silyl donor.

12. The method of claim 7 wherein the organo-silicon material is selected from the group consisting of polyalkylsiloxanes, polyalkylarylsiloxanes, and chlorosilanes.

13. The method of claim 12 wherein the composition comprises a polyalkylsiloxane selected from the group consisting of polymethylsiloxanes and polyethylsiloxanes.

14. The method of claim 12 wherein the composition comprises a polyalkylarylsiloxane and the polyalkylarylsiloxane is a polymethylphenylsiloxane.

15. The method of claim 12 wherein the composition comprises a chlorosilane selected from the group consisting of ethylchlorosilane and chlorotrimethylsilane.

16. The method of claim 1 wherein the composition comprises a material selected from the group consisting of alkoxysilanes, aroxysilanes, alkoxysiloxanes, and aroxysiloxanes.

17. The method of claim 16 wherein the material is selected from the group consisting of tetraethoxysilane, dimethoxydiphenylsilane, dichlorodimethylsilane, dichlorodiphenylsilane, poly(dimethylsiloxane and poly[oxy(dimethylsilylene)].

18. The method of claim 1 wherein the composition comprises a material selected from the group consisting of ethyl silicate and methyl sodium silanolate.

19. The method of claim 1 wherein the composition comprises a silicon resin.

20. The method of claim 19 wherein the silicon resin comprises a mixture of at least one silane ester and at least one silyl amine.

21. The method of claim 19 wherein the silicon resin is selected from the group consisting of tetraethyl orthosilicate, tetramethyl orthosilicate, tetra-n-propyl silicate, tetrabutyl glycol silicate, N-(t-butyldiphenylsilyl)cyclohexylamine and N-(t-butyidiphenylsilyl)benzylamine.

22. The method of claim 1 wherein the composition comprises an organofunctional silane.

23. The method of claim 22 wherein the organofunctional silane is selected from the group consisting of gamma-aminopropyltriethoxysilanes, N-beta-(aminoethyl)-gamma-aminopropyltrimethoxysilanes, aminoethyl-N-beta-(aminoethyl)-gamma-aminopropyl-trimethoxysilanes, gamma-ureidopropyl-triethoxysilanes, beta-(3-4epoxy-cyclohexyl)-ethyl-trimethoxysilanes and gamma-glycidoxypropyltrimethoxysilanes.

24. The method of claim 1 wherein the composition is coated onto the particles by spraying, blowing, or wet mixing.

25. A method for treating particles to make them water-repellent, comprising dissolving an oil-soluble composition in a solvent, admixing or spraying the resultant solution on the particles, and then evaporating the solvent to form a film encapsulating the particles.

26. The method of claim 25 wherein the film comprises an organo-silicon material.

27. The method of claim 26 wherein the organo-silicon material is selected from the group consisting of siloxanes and silanes.

28. The method of claim 25 wherein the composition comprises an organo-silicon material.

29. The method of claim 25 wherein the composition comprises a silyl donor.

30. The method of claim 28 wherein the organo-silicon material is selected from the group consisting of polyalkylsiloxanes, polyalkylarylsiloxanes, and chlorosilanes.

31. The method of claim 30 wherein the composition comprises a polyalkylsiloxane selected from the group consisting of polymethylsiloxanes and polyethylsiloxanes.

32. The method of claim 30 wherein the composition comprises a polyalkylarylsiloxane and the polyalkylarylsiloxane is a polymethylphenylsiloxane.

33. The method of claim 30 wherein the composition comprises a chlorosilane selected from the group consisting of ethylchlorosilane and chlorotrimethylsilane.

34. The method of claim 25 wherein the composition comprises a material selected from the group consisting of alkoxysilanes, aroxysilanes, alkoxysiloxanes, and aroxysiloxanes.

35. The method of claim 34 wherein the material is selected from the group consisting of tetraethoxysilane, dimethoxydiphenylsilane, dichlorodimethylsilane, dichlorodiphenylsilane, poly(dimethylsiloxane and poly[oxy(dimethylsilylene)].

36. The method of claim 25 wherein the composition comprises a material selected from the group consisting of ethyl silicate and methyl sodium silanolate.

37. The method of claim 25 wherein the composition comprises a silicon resin.

38. The method of claim 37 wherein the silicon resin comprises a mixture of at least one silane ester and at least one silyl amine.

39. The method of claim 37 wherein the silicon resin is selected from the group consisting of tetraethyl orthosilicate, tetramethyl orthosilicate, tetra-n-propyl silicate, tetrabutyl glycol silicate, N-(t-butyldiphenylsilyl)cyclohexylamine and N-(t-butyldiphenylsilyl)benzylamine.

40. The method of claim 25 wherein the composition comprises an organofunctional silane.

41. The method of claim 40 wherein the organofunctional silane is selected from the group consisting of gamma-aminopropyltriethoxysilanes, N-beta-(aminoethyl)-gamma-aminopropyltrimethoxysilanes, aminoethyl-N-beta-(aminoethyl)-gamma-aminopropyl-trimethoxysilanes, gamma-ureidopropyl-triethoxysilanes, beta-(3-4epoxy-cyclohexyl)-ethyl-trimethoxysilanes and gamma-glycidoxypropyltrimethoxysilanes.

42. A product made by coating particles with an organo-silicon compound.

43. The product of claim 42 wherein the particles are selected from the group consisting of sand and gravel.

44. The product of claim 42 wherein the particles comprise a man made material.

45. The product of claim 44 wherein the particles comprise a material selected from the group consisting of ceramic, bauxite, glass spheres, plastic particles, and curable resin-coated proppants.

46. The method of claim 42 wherein the composition comprises a silyl donor.

47. The product of claim 42 wherein the composition comprises an organo-silicon material selected from the group consisting of polyalkylsiloxanes, polyalkylarylsiloxanes, and chlorosilanes.

48. The product of claim 47 wherein the composition comprises a polyalkylsiloxane selected from the group consisting of polymethylsiloxanes and polyethylsiloxanes.

49. The product of claim 47 wherein the composition comprises a polyalkylarylsiloxane and the polyalkylarylsiloxane is a polymethylphenylsiloxane.

50. The product of claim 47 wherein the composition comprises a chlorosilane selected from the group consisting of ethylchlorosilane and chlorotrimethylsilane.

51. The product of claim 42 wherein the composition comprises a material selected from the group consisting of alkoxysilanes, aroxysilanes, alkoxysiloxanes, and aroxysiloxanes.

52. The product of claim 51 wherein the material is selected from the group consisting of tetraethoxysilane, dimethoxydiphenylsilane, dichlorodimethylsilane, dichlorodiphenylsilane, poly(dimethylsiloxane and poly[oxy(dimethylsilylene)].

53. The product of claim 42 wherein the composition comprises a material selected from the group consisting of ethyl silicate and methyl sodium silanolate.

54. The product of claim 42 wherein the composition comprises a silicon resin.

55. The product of claim 54 wherein the silicon resin comprises a mixture of at least one silane ester and at least one silyl amine.

56. The product of claim 54 wherein the silicon resin is selected from the group consisting of tetraethyl orthosilicate, tetramethyl orthosilicate, tetra-n-propyl silicate, tetrabutyl glycol silicate, N-(t-butyidiphenylsilyl)cyclohexylamine and N-(t-butyldiphenylsilyl)benzylamine.

57. The method of claim 42 wherein the composition comprises an organofunctional silane.

58. The method of claim 57 wherein the organofunctional silane is selected from the group consisting of gamma-aminopropyltriethoxysilanes, N-beta-(aminoethyl)-gamma-aminopropyltrimethoxysilanes, aminoethyl-N-beta-(aminoethyl)-gamma-aminopropyltrimethoxysilanes, gamma-ureidopropyl-triethoxysilanes, beta-(3-4epoxy-cyclohexyl)ethyl-trimethoxysilanes and gamma-glycidoxypropyltrimethoxysilanes.

59. The product of claim 42 wherein the particles are coated by dissolving an oil-soluble organo-silicon composition in a solvent, admixing or spraying the resultant solution on a plurality of particles, and then evaporating the solvent to form a film encapsulating the particles.

60. The product of claim 59 wherein the film comprises an organo-silicon material.

61. The product of claim 60 wherein the organo-silicon material is selected from the group consisting of siloxanes and silanes.

62. The product of claim 42 wherein the particles are coated by spraying, blowing, or wet mixing.

63. A method for treating a hydrocarbon producing well comprising mixing particles in a carrier fluid comprising a water-based polymer to form a mixture, pumping the mixture downhole in a well to form a gravel pack, and coating the particles with a water repellent composition wherein the particles are coated before being mixed in the carrier fluid whereby the coating prevents absorption of the water-based polymer on the surfaces of the particles.

64. The method of claim 63 wherein the water repellent composition comprises an organo-silicon composition.

65. The method of claim 63 wherein the carrier fluid comprises water and a gelling agent.

66. The method of claim 65 wherein the carrier fluid further comprises a crosslinking agent.

67. The method of claim 65 wherein the water component of the carrier fluid is selected from the group consisting of fresh water, salt water and brine.

68. The method of claim 65 wherein the gelling agent component of the carrier fluid comprises a hydratable polymer which includes at least one functional group selected from the group consisting of hydroxyl, cis-hydroxyl, carboxyl, sulfate, sulfonate, amino and amide.

69. The method of claim 68 wherein the hydratable polymer is a polysaccharide or a derivative thereof which includes at least one monosaccharide unit selected from the group consisting of galactose, mannose, glucoside, glucose, xylose, arabinose, fructose, glucuronic acid and pyranosyl sulfate.

70. The method of claim 69 wherein the hydratable polymer is selected from the group consisting of guar gum, locust bean gum, tara, konjac, tamarind, starch, cellulose, karaya gum, xanthan gum, tragacanth gum, carrageenan gum and derivatives thereof.

71. The method of claim 68 wherein the hydratable synthetic polymer is selected from the group consisting of polyacrylate, polymethacrylate, polyacrylamide, maleic anhydride, methylvinyl ether polymers, polyvinyl alcohol and polyvinylpyrrolidone.

72. The method of claim 66 wherein the crosslinking agent comprises a multivalent metal salt.

73. The method of claim 66 wherein the crosslinking agent comprises a compound which releases multivalent metal ions in an aqueous solution.

74. The method of claim 73, wherein the multivalent metal ions are selected from the group consisting of chromium, zirconium, antimony, titanium, ferrous iron, ferric iron, zinc and aluminum.

75. A method for treating a hydrocarbon producing well comprising mixing particles in a carrier fluid comprising a water-based polymer to form a mixture, pumping the mixture downhole in a well to a fracture in a formation adjacent the well to function as a proppant, and coating the particles with a water repellent composition, wherein the particles are coated before being mixed in the carrier fluid whereby the coating prevents absorption of the water-based polymer on the surfaces of the particles.

76. The method of claim 75 wherein the water repellent composition comprises an organo-silicon composition.

77. The method of claim 75 wherein the carrier fluid comprises water and a gelling agent.

78. The method of claim 77 wherein the carrier fluid further comprises a crosslinking agent.

79. The method of claim 77 wherein the water component of the carrier fluid is selected from the group consisting of fresh water, salt water and brine.

80. The method of claim 77 wherein the gelling agent component of the carrier fluid comprises a hydratable polymer which includes at least one functional group selected from the group consisting of hydroxyl, cis-hydroxyl, carboxyl, sulfate, sulfonate, amino and amide.

81. The method of claim 80 wherein the hydratable polymer is a polysaccharide or a derivative thereof which includes at least one monosaccharide unit selected from the group consisting of galactose, mannose, glucoside, glucose, xylose, arabinose, fructose, glucuronic acid and pyranosyl sulfate.

82. The method of claim 81 wherein the hydratable polymer is selected from the group consisting of guar gum, locust bean gum, tara, konjac, tamarind, starch, cellulose, karaya gum, xanthan gum, tragacanth gum, carrageenan gum and derivatives thereof.

83. The method of claim 80 wherein the hydratable synthetic polymer is selected from the group consisting of polyacrylate, polymethacrylate, polyacrylamide, maleic anhydride, methylvinyl ether polymers, polyvinyl alcohol and polyvinylpyrrolidone.

84. The method of claim 78 wherein the crosslinking agent comprises a multivalent metal salt.

85. The method of claim 78 wherein the crosslinking agent comprises a compound which releases multivalent metal ions in an aqueous solution.

86. The method of claim 85, wherein the multivalent metal ions are selected from the group consisting of chromium, zirconium, antimony, titanium, ferrous iron, ferric iron, zinc and aluminum.
